(19) United States
(12) Patent Application Publication
(10) Pub. No.: US 2021/0250937 A1
(43) Pub. Date: Aug. 12, 2021

(54) INDICATING BEAM INFORMATION IN A RANDOM ACCESS CHANNEL PROCEDURE

(71) Applicant: QUALCOMM Incorporated, San Diego, CA (US)

(72) Inventors: Sungwoo PARK, Seoul (KR); Wooseok NAM, San Diego, CA (US); Kiran VENUGOPAL, Raritan, NJ (US); Tianyang BAI, Somerville, NJ (US); Tao LUO, San Diego, CA (US)

(21) Appl. No.: 17/248,824

(22) Filed: Feb. 9, 2021

Related U.S. Application Data
(60) Provisional application No. 62/972,971, filed on Feb. 11, 2020.

(51) Int. Cl. H04W 72/04; H04W 74/08; H04W 68/00; H04L 5/00

(52) U.S. Cl. CPC H04W 72/046; H04W 72/048; H04W 72/0413; H04W 68/005; H04L 5/0032; H04W 74/0833

(57) ABSTRACT

Various aspects of the present disclosure generally relate to wireless communication. In some aspects, a user equipment (UE) may transmit beam information, associated with the UE, during a random access channel (RACH) procedure and while in an inactive mode or in an idle mode. The UE may remain in the inactive mode or in the idle mode after transmitting the beam information. Numerous other aspects are provided.

### CROSS-REFERENCE TO RELATED APPLICATION

This Patent Application claims priority to U.S. Provisional Patent Application No. 62,972/971, filed on Feb. 11, 2020, entitled “INDICATING BEAM INFORMATION IN A RANDOM ACCESS CHANNEL PROCEDURE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for indicating beam information in a random access channel procedure.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include transmitting beam information, associated with the UE, during a random access channel (RACH) procedure and while in an inactive mode or in an idle mode; and remaining in the inactive mode or in the idle mode after transmitting the beam information.

In some aspects, a UE for wireless communication may include a memory and one or more processors operatively coupled to the memory. The memory and the one or more processors may be configured to transmit beam information, associated with the UE, during a RACH procedure and while in an inactive mode or in an idle mode; and remain in the inactive mode or in the idle mode after transmitting the beam information.

In some aspects, a non-transitory computer-readable medium may store one or more instructions for wireless communication. The one or more instructions, when executed by one or more processors of a UE, may cause the one or more processors to transmit beam information, associated with the UE, during a RACH procedure and while in an inactive mode or in an idle mode; and remain in the inactive mode or in the idle mode after transmitting the beam information.

In some aspects, an apparatus for wireless communication may include means for transmitting beam information, associated with the apparatus, during a RACH procedure and while in an inactive mode or in an idle mode; and means for remaining in the inactive mode or in the idle mode after transmitting the beam information.

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram conceptually illustrating an example of a wireless communication network, in accordance with various aspects of the present disclosure.

FIG. 2 is a diagram conceptually illustrating an example of a base station in communication with a user equipment (UE) in a wireless communication network, in accordance with various aspects of the present disclosure.

FIGS. 3-7 are diagram illustrating examples of indicating beam information in a random access channel procedure, in accordance with various aspects of the present disclosure.

FIG. 8 is a diagram illustrating an example process performed, for example, by a UE, in accordance with various aspects of the present disclosure.

FIG. 9 is a diagram illustrating an example apparatus for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

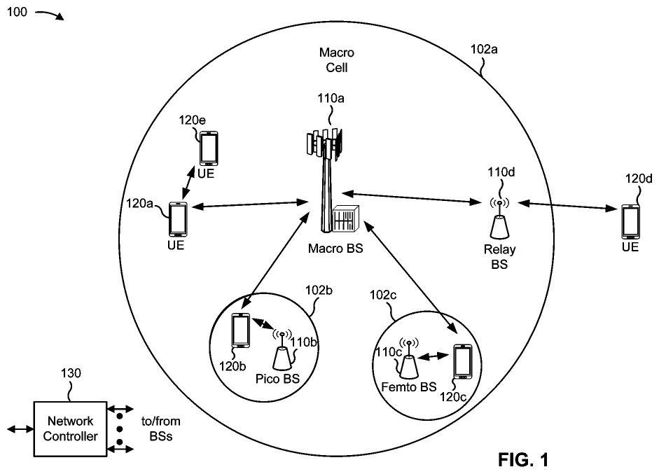

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

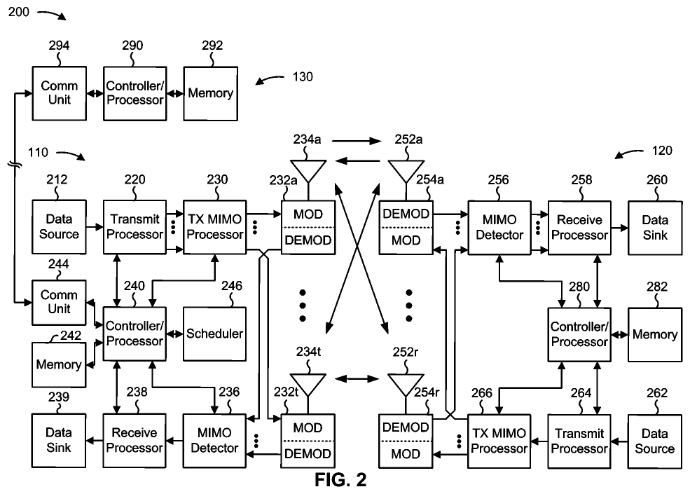

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

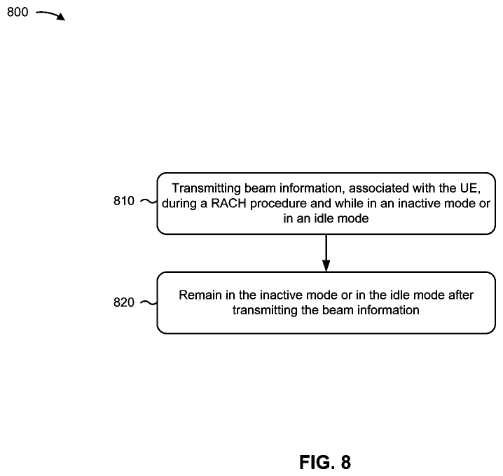

Controller/processor 240 of base station 110, controller/processor 280 of UE 120, and/or any other component(s) of FIG. 2 may perform one or more techniques associated with indicating beam information in a random access channel (RACH) procedure, as described in more detail elsewhere herein. For example, controller/processor 240 of base station 110, controller/processor 280 of UE 120, and/or any other component(s) of FIG. 2 may perform or direct operations of, for example, process 800 of FIG. 8 and/or other processes as described herein. Memories 242 and 282 may store data and program codes for base station 110 and UE 120, respectively.

In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 800 of FIG. 8 and/or other processes as described herein. A scheduler 246 may schedule UEs for data transmission on the downlink and/or uplink.

In some aspects, UE 120 may include means for transmitting beam information, associated with the UE, during a RACH procedure and while in an inactive mode or in an idle mode, means for remaining in the inactive mode or in the idle mode after transmitting the beam information, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

As indicated above, FIG. 2 is provided as an example. Other examples may differ from what is described with regard to FIG. 2.

A UE may perform a discontinuous reception (DRX) operation while in various communication modes, such as a connected mode (e.g., a radio resource control (RRC) connected or active mode, where the UE is actively communicatively connected with a BS), an inactive mode (e.g., an RRC inactive mode in which the UE suspends the connection with the BS to conserve battery life), in an idle mode (e.g., an RRC idle mode in which the UE is not communicatively connected with the BS), and/or the like. In DRX operation, the UE may increase battery conservation by periodically transitioning to a DRX sleep mode for a DRX sleep duration. In the DRX sleep mode, the UE may refrain from transmitting or receiving on the access link, may deactivate particular subcarriers or component carriers (e.g., if carrier aggregation is implemented on the access link) of the access link, may deactivate one or more components of the UE, and/or the like.

While performing the DRX operation in an inactive mode or idle mode, the UE may periodically transition out of the DRX sleep mode and into a DRX on mode (or activate mode) for a DRX on duration to monitor for paging communications from a BS. The BS may transmit a paging communication to the UE as an indication that one or more downlink communications are queued or scheduled to be transmitted to the UE. In this case, the UE may receive the paging communication and may perform a random access channel procedure to establish a connection with the BS and to transition from the inactive mode or the idle mode and into a connected mode. The UE may receive the one or more downlink communications while in the connected mode.

In some cases, a UE may communicate with a BS using one or more beams (e.g., transmit beams) associated with the BS. In this case, the BS may transmit downlink communications to the UE using the one or more beams. For example, the UE and/or the BS may select the one or more beams (e.g., beams that are the best beams for transmission to the UE, beams that satisfy signal strength and/or signal quality threshold, and/or the like) and may communicate using the selected beams.

If the UE is in an idle mode or an inactive mode, the BS may be capable of transmitting a paging communication to the UE using one of the selected beams. However, due to UE mobility and/or other factors, the best beam(s) (or beams that satisfied the signal strength and/or signal quality thresholds) that were selected prior to the UE transitioning to the idle mode or the inactive mode may be outdated, inaccurate, and/or otherwise no longer the best beam(s) for the UE.

As a result, the BS may perform beam sweeping when transmitting a paging communication to the UE while the UE is in an idle mode or an inactive mode. To beam sweep the paging communication, the BS may transmit the paging communication on each transmit beam of the BS in a paging occasion during a DRX on duration of the UE. The BS may beam sweep the paging communication in a particular beam order or sequence. For example, the BS may transmit the paging communication on each beam in a clockwise order, a counter-clockwise order, or another order or sequence.

The increased quantity of transmissions of the paging communication due to beam sweeping the paging communication results in increased radio resource consumption, increased use of processing and/or memory resources of the B S, an increase in latency in the paging communication being received at the UE, and/or the like. Moreover, the BS may beam sweep the paging communication in subsequent paging occasions during subsequent DRX on durations of the UE until the UE receives the paging communication and initiates a RACH procedure with the BS, further increasing radio resource consumption, use of processing and/or memory resources of the BS, latency in the paging communication being received at the UE, and/or the like.

Some aspects described herein provide techniques and apparatuses for indicating beam information in a RACH procedure. In some aspects, a UE may (e.g., periodically, based at least in part on event, and/or the like) initiate a RACH procedure with a BS while the UE is in an idle mode or an inactive mode. The UE may provide beam information to the BS during the RACH procedure such that the BS receives the most up-to-date or recent beam information associated with the UE. The beam information may indicate one or more best beams for the UE, one or more preferred beams for the UE, one or more beams that satisfy various threshold (e.g., a signal strength threshold, a signal quality threshold, and/or the like), and/or the like.

In this way, the BS may page the UE using the beam information received during the RACH procedure by transmitting a paging communication to the UE using the one or more beams indicated by the beam information. This reduces or eliminates the need for the BS to beam sweep the paging communication, which decreases radio resource consumption, decreases the use of processing and/or memory resources of the BS, decreases latency in the paging communication being received at the UE, and/or the like. Moreover, once the UE provides the beam information to the BS during the RACH procedure, the UE may terminate the RACH procedure or complete the RACH procedure without transitioning out of the idle mode or the inactive mode. This reduces interruptions in DRX operation of the UE and permits the UE to remain in DRX operation for increased battery saving purposes, which can extend the battery life of reduced capability UEs and/or IoT devices.

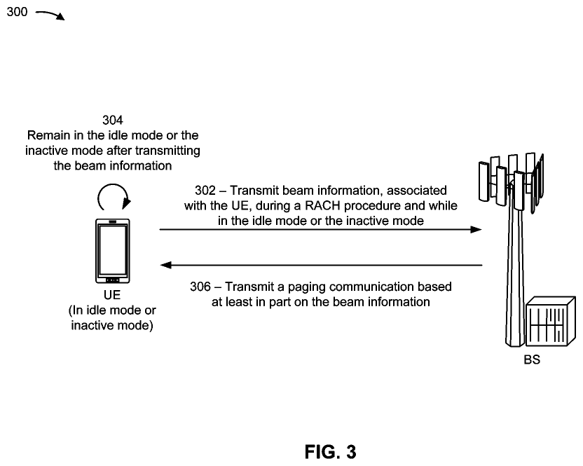

FIG. 3 is a diagram illustrating an example 300 of indicating beam information in a RACH procedure, in accordance with various aspects of the present disclosure. As shown in FIG. 3, example 300 may include communication between a UE (e.g., a UE 120) and a BS (e.g., a BS 110). In some aspects, the UE and the BS may be included in a wireless network such as wireless network 100. In some aspects, the UE and the BS may communicate via a wireless access link, which may include a downlink and an uplink.

In some aspects, the UE may be a reduced capability (RedCap) UE or an IoT device. RedCap may include a category of UEs that have a less advanced capability (e.g., a lower capability and/or a reduced capability) relative to a category of UEs that have a more advanced capability (e.g., a higher capability). A RedCap UE may include a reduced feature set compared to the UEs that have a more advanced capability and may be referred to as a reduced capability (RedCap) UE, a low tier UE, and/or an NR-Lite UE, among other examples.

A RedCap UE may be, for example, an MTC UE, an eMTC UE, and/or an IoT UE, as described above in connection with FIG. 1. A UE including more advanced feature set compared to RedCap UEs may be referred to as a baseline UE, a high tier UE, an NR UE, and/or a premium UE, among other examples. In some aspects, a RedCap UE of the first category has capabilities that satisfy requirements of a first (earlier) wireless communication standard but not a second (later) wireless communication standard, while a baseline UE includes more advanced capabilities that satisfy requirements of the second (later) wireless communication standard (and also the first wireless communication standard, in some cases).

As shown in FIG. 3, the UE may be in an idle mode or an inactive mode. In the inactive mode, the UE is communicatively connected with the BS, but the RRC configuration for the connection is suspended. In the idle mode, the UE may not have a communicative connection established with the UE. In ether mode, the UE may perform DRX operation for battery conservation purposes. The BS may transmit a paging communication to the UE during one or more paging occasions during one or more DRX on durations to cause the UE to initiate a RACH procedure with the BS to establish or resume a connection with the BS.

As further shown in FIG. 3, and by reference number 302, the UE may initiate a RACH procedure with the BS, and may transmit beam information, associated with the UE, during RACH procedure and while in the idle mode or the inactive mode. In some aspects, the UE may periodically initiate a RACH procedure to transmit beam information to the BS at a particular or specified time interval. In some aspects, the UE may initiate a RACH procedure to transmit beam information to the BS based at least in part on an event. For example, the UE may initiate a RACH procedure to transmit beam information to the BS based at least in part on mobility of the UE. In this case, the UE may initiate a RACH procedure to transmit beam information to the BS based at least in part on determining that the UE has moved a threshold distance while in the idle mode or the inactive mode, based at least in part on determining that the UE has moved a threshold distance within a particular time period, and/or the like.

In some aspects, the beam information may identify one or more beams (e.g., transmit beams of the UE) on which the UE is to be paged while the UE is in the idle mode or the inactive mode. The one or more beams may be one or more best beams for the UE, one or more preferred beams for the UE, one or more beams that satisfy various threshold (e.g., a signal strength threshold, a signal quality threshold, and/or the like), and/or the like. The one or more beams may be wide beams, narrow beams, a combination of wide beams and narrow beams, and/or other types of beams.

As further shown in FIG. 3, and by reference number 304, the UE may remain in the idle mode or the inactive mode after transmitting the beam information to the UE. For example, the UE may terminate the RACH procedure early (e.g., without completing the RACH procedure), which may cause the UE to remain in the idle mode or the inactive mode.

As another example, the UE may complete the RACH procedure, but may refrain from completing the RRC connection establishment with the BS, which may cause the UE to remain in the idle mode or the inactive mode. In these examples, the UE may ignore or refrain from responding to a medium access control (MAC) control element (MAC-CE) contention resolution identifier communication, transmitted from the BS, that includes an RRCSetup command. Accordingly, the UE remains in DRX operation in the idle mode or the inactive mode, thereby permitting the UE to conserve battery resources.

As further shown in FIG. 3, and by reference number 306, the BS may transmit a paging communication to the UE based at least in part on the beam information received during the RACH procedure. For example, the BS may transmit the paging communication to the UE on a beam indicated in the beam information. The BS may transmit the paging communication on the beam in a paging occasion during a DRX on duration of the UE.

In some aspects, the BS may transmit the paging communication in the paging occasion without the use of beam sweeping. In these examples, the BS transmits the paging communication on only the one or more beams indicated in the beam information. In some aspects, the BS may perform partial beam sweeping in the paging occasion by transmitting the paging communication on the one or more beams indicated in the beam information as well as the beams spatially or directionally adjacent to the one or more beams.

In some aspects, the BS may perform full beam sweeping in a beam order or sequence in which the one or more beams indicated in the beam information are transmitted first. In these examples, if the BS is configured to beam sweep in a particular beam order or sequence, the BS may swap the one or more beams with one or more other beams that would have otherwise been transmitted first. Accordingly, the BS may transmit the one or more beams first and may transmit the one or more beams in the positions in the beam order or sequence in which the one or more beams were to originally be transmitted.

In some aspects, the BS may combine one or more of the techniques described above. For example, the BS may initially transmit the paging communication in the paging occasion without the use of beam sweeping. In some aspects, if the UE does not respond to the paging communication, the BS may perform partial or full beam sweeping in the next paging occasion, in all subsequent paging occasions until the UE initiates a RACH procedure with the BS, or in a particular quantity of paging occasions. In some aspects, if the UE does not respond to the paging communication in the next paging occasion or in the particular quantity of paging occasions, the BS may perform full beam sweeping until the UE initiates the RACH procedure.

In this way, the BS may page the UE using the beam information received during the RACH procedure by transmitting a paging communication to the UE using the one or more beams indicated by the beam information. This reduces or eliminates the need for the BS to beam sweep the paging communication, which decreases radio resource consumption, decreases the use of processing and/or memory resources of the BS, decreases latency in the paging communication being received at the UE, and/or the like. Moreover, once the UE provides the beam information to the BS during the RACH procedure, the UE may terminate the RACH procedure or complete the RACH procedure without transitioning out of the idle mode or the inactive mode. This reduces interruptions in DRX operation of the UE and permits the UE to remain in DRX operation for increased battery saving purposes.

As indicated above, FIG. 3 is provided as an example. Other examples may differ from what is described with respect to FIG. 3.

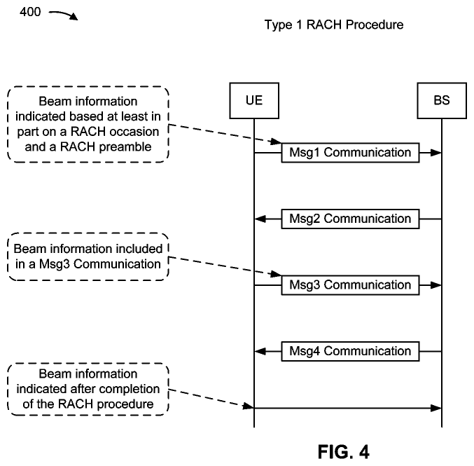

FIG. 4 is a diagram illustrating an example 400 of indicating beam information in a RACH procedure, in accordance with various aspects of the present disclosure. As shown in FIG. 4, example 400 may include communication between a UE (e.g., the UE 120 illustrated and described in connection with FIGS. 1 and 2, the UE illustrated and described in connection with FIG. 3, and/or the like) and a BS (e.g., the BS 110 illustrated and described in connection with FIGS. 1 and 2, the BS illustrated and described in connection with FIG. 3, and/or the like). In some aspects, the UE and the BS may be included in a wireless network such as wireless network 100. In some aspects, the UE and the BS may communicate via a wireless access link, which may include a downlink and an uplink. In some aspects, the UE may be a RedCap UE or an IoT device.

In some aspects, the UE may be in an idle mode or an inactive mode. In ether mode, the UE may perform DRX operation for battery conservation purposes. In some aspects, BS may transmit a paging communication to the UE during one or more paging occasions during one or more DRX on durations to cause the UE to initiate a RACH procedure with the BS to establish or resume a connection with the BS.

As shown in FIG. 4, the UE may transmit beam information to the BS during a RACH procedure with the BS and while in the idle mode or the inactive mode. In some aspects, the UE may transmit the beam information using one or more of the techniques described above in connection with FIG. 3. The beam information may include one or more types of information described above in connection with FIG. 3, and/or other types of beam information.

As further shown in FIG. 4, the RACH procedure may include a Type 1 RACH procedure. In a Type 1 RACH procedure, the UE and the BS may exchange four primary RACH communications. The UE may transmit a Message 1 (Msg1) communication to the BS (e.g., as defined in a 3GPP Type 1 RACH procedure). The Msg1 communication may be a RACH preamble communication that is transmitted in a RACH occasion, the combination of which may be referred to as a RACH signature. The BS may respond to the Msg1 communication with a Message 2 (Msg2) communication (e.g., as defined in a 3GPP Type 1 RACH procedure), which may be a random access response (RAR) communication. The UE may respond to the Msg2 communication with a Message 3 (Msg3) communication (e.g., as defined in a 3GPP Type 1 RACH procedure), which may be an RRC connection request communication. The BS may respond to the Msg3 communication with a Message 4 (Msg4) communication (e.g., as defined in a 3GPP Type 1 RACH procedure), which may be a MAC-CE contention resolution identifier communication and may include an RRCSetup command, and/or the like.

As further shown in FIG. 4, the UE may transmit the beam information to the BS at various times and/or in various types of communications during the Type 1 RACH procedure. For example, the UE may transmit the Msg1 communication with a RACH preamble that has a RACH signature associated with a beam indicated by the beam information. In these examples, the transmission of RACH preamble of the Msg1 communication in a RACH occasion associated with the beam, and with a particular RACH preamble sequence associated with the beam (the combination of which is the RACH signature of the beam), may implicitly indicate the beam on which the BS is to transmit paging communications to the UE. As another example, the UE may transmit the beam information in a Msg3 communication. As another example, the UE may transmit the beam information after completion of the RACH procedure (e.g., after the Msg4 communication is received from the BS), but while refraining from transitioning to a connected mode with the BS.

As indicated above, FIG. 4 is provided as an example. Other examples may differ from what is described with respect to FIG. 4.

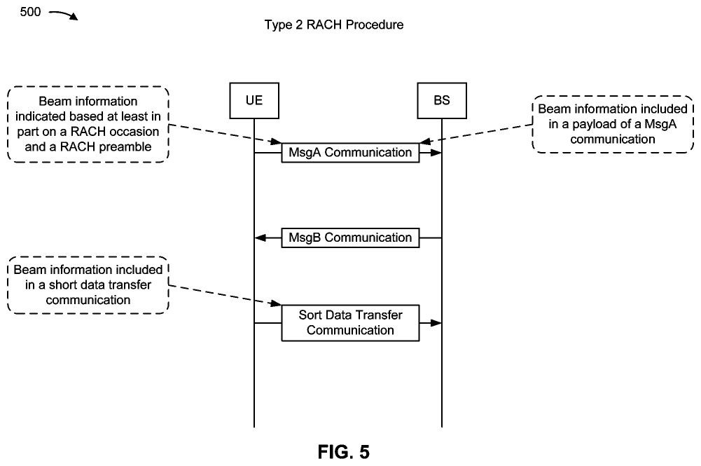

FIG. 5 is a diagram illustrating an example 500 of indicating beam information in a RACH procedure, in accordance with various aspects of the present disclosure. As shown in FIG. 5, example 500 may include communication between a UE (e.g., the UE 120 illustrated and described in connection with FIGS. 1 and 2, the UE illustrated and described in connection with FIG. 3, and/or the like) and a BS (e.g., the BS 110 illustrated and described in connection with FIGS. 1 and 2, the BS illustrated and described in connection with FIG. 3, and/or the like). In some aspects, the UE and the BS may be included in a wireless network such as wireless network 100. In some aspects, the UE and the BS may communicate via a wireless access link, which may include a downlink and an uplink. In some aspects, the UE may be a RedCap UE or an IoT device.

In some aspects, the UE may be in an idle mode or an inactive mode. In either mode, the UE may perform a DRX operation for battery conservation purposes. In some aspects, BS may transmit a paging communication to the UE during one or more paging occasions during one or more DRX on durations to cause the UE to initiate a RACH procedure with the BS to establish or resume a connection with the BS.

As shown in FIG. 5, the UE may transmit beam information to the BS during a RACH procedure with the BS and while in the idle mode or the inactive mode. In some aspects, the UE may transmit the beam information using one or more of the techniques described above in connection with FIG. 3. The beam information may include one or more types of information described above in connection with FIG. 3, and/or other types of beam information.

As further shown in FIG. 5, the RACH procedure may include a Type 2 RACH procedure. In a Type 2 RACH procedure, the UE may transmit some of information from a Msg1 communication and Msg3 communication in a combined communication referred to as a message A (MsgA) communication (e.g., as defined in a 3GPP Type 2 RACH procedure). For example, the MsgA communication may include a preamble portion (e.g., a RACH preamble) and a payload portion. The BS may receive the MsgA communication and may transmit a message B (MsgB) communication (e.g., as defined in a 3GPP Type 2 RACH procedure), which may include some of the information from a Msg2 communication and a Msg4 communication in a combined communication.

As further shown in FIG. 5, the UE may transmit the beam information to the BS at various times and/or in various types of communications during the Type 2 RACH procedure. For example, the UE may transmit a RACH preamble in a MsgA communication. The RACH preamble may have a RACH signature associated with a beam indicated by the beam information. In these examples, the transmission of RACH preamble in a RACH occasion associated with the beam and with a particular RACH preamble sequence associated with the beam (the combination of which is the RACH signature of the beam) may implicitly indicate the beam on which the BS is to transmit paging communications to the UE. As another example, the UE may transmit the beam information in the payload portion of the MsgA communication. As another example, the UE may transmit the beam information after receiving a MsgB communication from the BS, such as in a short data transfer communication (which may also be referred to as a small data transmission).

As indicated above, FIG. 5 is provided as an example. Other examples may differ from what is described with respect to FIG. 5.

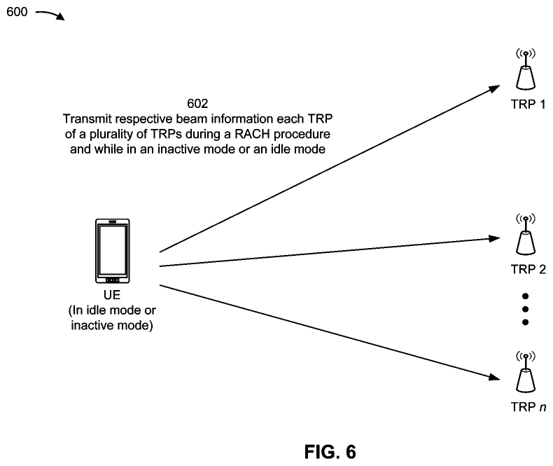

FIG. 6 is a diagram illustrating an example 600 of indicating beam information in a RACH procedure, in accordance with various aspects of the present disclosure. As shown in FIG. 6, example 600 may include communication between a UE (e.g., the UE 120 illustrated and described in connection with FIGS. 1 and 2, the UE illustrated and described in connection with FIG. 3, and/or the like) and a plurality of TRPs (e.g., TRP 1 through TRP n). In some aspects, each TRP may be associated with a BS (e.g., the BS 110 illustrated and described in connection with FIGS. 1 and 2, the BS illustrated and described in connection with FIG. 3, 4, and/or 5, and/or the like). In some aspects, one or more of the TRPs may be associated with the same BS. In some aspects, the UE and the TRPs may be included in a wireless network such as wireless network 100. In some aspects, the UE and the TRPs may communicate via a wireless access link, which may include a downlink and an uplink.

In some aspects, the UE may be in an idle mode or an inactive mode. In ether mode, the UE may perform a DRX operation for battery conservation purposes. In some aspects, TRPs may transmit a paging communication to the UE during one or more paging occasions during one or more DRX on durations to cause the UE to initiate a RACH procedure with the TRPs to establish or resume a connection with the TRPs.

As shown in FIG. 6, the UE may transmit beam information to the TRPs during a RACH procedure with the BS and while in the idle mode or the inactive mode. In some aspects, the UE may transmit the beam information using one or more of the techniques described above in connection with FIG. 3. The beam information may include one or more types of information described above in connection with FIG. 3, and/or other types of beam information.

As further shown in FIG. 6, and by reference number 602, the UE may transmit respective beam information to each TRP of the plurality to TRPs during a RACH procedure and while in an inactive or an idle mode. In some aspects, the UE may simultaneously perform the RACH procedures for all or a subset of the TRPs. In some aspects, the UE may perform the RACH procedures for all or a subset of the TRPs at different times. In some aspects, the beam information transmitted to each TRP may include beam information for all of the plurality of TRPs. For example, the beam information may include an indication of a respective set of one or more beams, associated with the UE, for each of the TRPs (e.g., a set of one or more transmit beams of TRP 1, a set of one or more transmit beams of TRP 2, and so on). In this way, each of the plurality of TRPs is aware of the beam information for the other TRPs in the plurality of TRPs.

As indicated above, FIG. 6 is provided as an example. Other examples may differ from what is described with respect to FIG. 6.

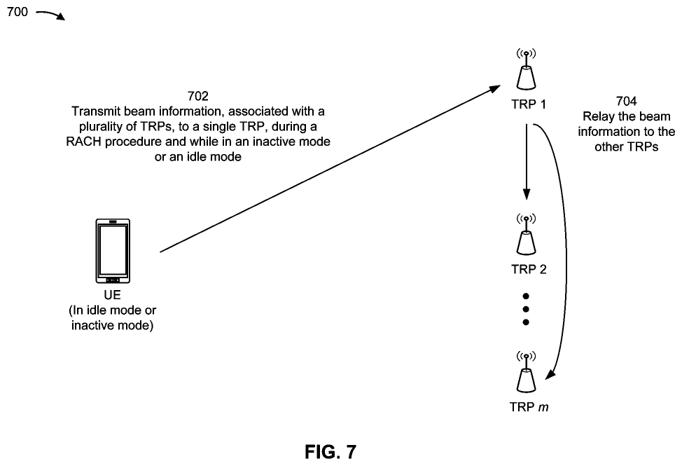

FIG. 7 is a diagram illustrating an example 700 of indicating beam information in a RACH procedure, in accordance with various aspects of the present disclosure. As shown in FIG. 7, example 700 may include communication between a UE (e.g., the UE 120 illustrated and described in connection with FIGS. 1 and 2, the UE illustrated and described in connection with FIG. 3, and/or the like) and a plurality of TRPs (e.g., TRP 1 through TRP m). In some aspects, each TRP may be associated with a BS (e.g., the BS 110 illustrated and described in connection with FIGS. 1 and 2, the BS illustrated and described in connection with FIG. 3, 4, and/or 5, and/or the like). In some aspects, one or more of the TRPs may be associated with the same BS. In some aspects, the UE and the TRPs may be included in a wireless network such as wireless network 100. In some aspects, the UE and the TRPs may communicate via a wireless access link, which may include a downlink and an uplink.

In some aspects, the UE may be in an idle mode or an inactive mode. In ether mode, the UE may perform a DRX operation for battery conservation purposes. In some aspects, TRPs may transmit a paging communications to the UE during one or more paging occasions during one or more DRX on durations to cause the UE to initiate a RACH procedure with the TRPs to establish or resume a connection with the TRPs.

As shown in FIG. 7, the UE may transmit beam information to the TRPs during a RACH procedure with the BS and while in the idle mode or the inactive mode. In some aspects, the UE may transmit the beam information using one or more of the techniques described above in connection with FIG. 3. The beam information may include one or more types of information described above in connection with FIG. 3, and/or other types of beam information.

As further shown in FIG. 7, and by reference number 702, the UE may transmit beam information for each TRP of the plurality to TRPs to a single TRP (e.g., TRP 1) during a RACH procedure with the TRP and while in an inactive or an idle mode. In some aspects, the beam information may include an indication of a respective set of one or more beams, associated with the UE, for each of the TRPs (e.g., a set of one or more transmit beams of TRP 1, a set of one or more transmit beams of TRP 2, and so on).

In some aspects, the UE may transmit the beam information to the TRP at various times during the RACH procedure. For example, if the RACH procedure is a Type 1 RACH procedure, the UE may transmit the beam information at the various times and/or in the various types of communications described above in connection with FIG. 4. As another example, if the RACH procedure is a Type 2 RACH procedure, the UE may transmit the beam information at the various times and/or in the various types of communications described above in connection with FIG. 5.

In some aspects, the UE may transmit the beam information for all the TRPs at the same time and/or in the same communication. For example, the UE may transmit the beam information for all the TRPs in a Msg3 communication in the Type 1 RACH procedure. As another example, the UE may transmit the beam information for all the TRPs in a payload portion of a MsgA communication in the Type 1 RACH procedure.

In some aspects, the UE may transmit the beam information associated with the TRP to which the UE is transmitting the beam information in at a different time and/or in a different communication than the beam information associated with other TRPs of the plurality of TRPs. For example, the UE may indicate the beam information associated with TRP 1 based at least in part on the combination of the RACH preamble transmitted by the UE and the RACH occasion in which the RACH preamble is transmitted, and the UE may transmit the beam information for the other TRPs in one or more of a Msg3 communication in a Type 1 RACH procedure, in a payload portion of a MsgA communication in a Type 2 RACH procedure, in a communication after completion of a Type 1 RACH procedure, in a short data transfer communication (e.g., a small data transmission) in a Type 2 RACH procedure, and/or the like.

As further shown in FIG. 7, and by reference number 704, the TRP may receive the beam information and may transmit, forward, or otherwise relay the information to the other TRPs of the plurality of TRPs. In some aspects, the TRP may transmit the beam information to the other TRPs via a backhaul link, a wireless link, via a core network and/or via other paths. In this way, each of the plurality of TRPs is aware of the beam information for the other TRPs in the plurality of TRPs.

As indicated above, FIG. 7 is provided as an example. Other examples may differ from what is described with respect to FIG. 7.

FIG. 8 is a diagram illustrating an example process 800 performed, for example, by a UE, in accordance with various aspects of the present disclosure. Example process 800 is an example where the UE (e.g., UE 120 illustrated in FIGS. 1 and 2, the UE illustrated in FIGS. 3, 4, 5, 6, and/or 7, and/or the like) performs operations associated with indicating beam information in a RACH procedure.

As shown in FIG. 8, in some aspects, process 800 may include transmitting beam information, associated with the UE, during a RACH procedure and while in an inactive mode or in an idle mode (block 810). For example, the UE (e.g., using receive processor 258, transmit processor 264, controller/processor 280, memory 282, and/or the like) may transmit beam information, associated with the UE, during a RACH procedure and while in an inactive mode or in an idle mode, as described above.

As further shown in FIG. 8, in some aspects, process 800 may include remaining in the inactive mode or in the idle mode after transmitting the beam information (block 820). For example, the UE (e.g., using receive processor 258, transmit processor 264, controller/processor 280, memory 282, and/or the like) may remain in the inactive mode or in the idle mode after transmitting the beam information, as described above.

Process 800 may include additional aspects, such as any single aspect or any combination of aspects described below and/or in connection with one or more other processes described elsewhere herein.

In a first aspect, the beam information identifies one or more beams on which the UE is to be paged while the UE is in the inactive mode or in the idle mode. In a second aspect, alone or in combination with the first aspect, transmitting the beam information comprises transmitting the beam information based at least in part on mobility of the UE. In a third aspect, alone or in combination with one or more of the first and second aspects, the RACH procedure is a type 1 RACH procedure, and transmitting the beam information comprises transmitting the beam information in a Msg1 communication in the type 1 RACH procedure, wherein a combination of a RACH preamble of the Msg1 communication and a RACH occasion in which the Msg1 communication is transmitted implicitly indicates the beam information.

In a fourth aspect, alone or in combination with one or more of the first through third aspects, the RACH procedure is a type 2 RACH procedure, and transmitting the beam information comprises transmitting the beam information in a MsgA communication in the type 2 RACH procedure, wherein a combination of a RACH preamble of the MsgA communication and a RACH occasion in which the MsgA communication is transmitted implicitly indicates the beam information. In a fifth aspect, alone or in combination with one or more of the first through fourth aspects, the RACH procedure is a type 1 RACH procedure, and transmitting the beam information comprises transmitting the beam information in Msg3 communication in the type 1 RACH procedure.

In a sixth aspect, alone or in combination with one or more of the first through fifth aspects, the RACH procedure is a type 1 RACH procedure, and transmitting the beam information comprises transmitting the beam information after completing the type 1 RACH procedure. In a seventh aspect, alone or in combination with one or more of the first through sixth aspects, the RACH procedure is a type 2 RACH procedure, and transmitting the beam information comprises transmitting the beam information in a payload of a MsgA communication in the type 2 RACH procedure. In an eighth aspect, alone or in combination with one or more of the first through seventh aspects, the RACH procedure is a type 2 RACH procedure, and transmitting the beam information comprises transmitting the beam information in a short data transfer communication (e.g., a small data transmission) after receiving a MsgB communication in the type 2 RACH procedure.

In a ninth aspect, alone or in combination with one or more of the first through eighth aspects, the beam information identifies a respective set of beams for each TRP of a plurality of TRPs, and transmitting the beam information comprises transmitting the beam information to each TRP of the plurality of TRPs during respective RACH procedures associated with each TRP of the plurality of TRPs and while in the inactive mode or in the idle mode. In a tenth aspect, alone or in combination with one or more of the first through ninth aspects, the beam information identifies a respective set of beams for each TRP of a plurality of TRPs, and transmitting the beam information comprises transmitting the beam information to a TRP of the plurality of TRPs during the RACH procedure and while in the inactive mode or in the idle mode.

In an eleventh aspect, alone or in combination with one or more of the first through tenth aspects, transmitting the beam information comprises transmitting, to the TRP and in a Msg1 communication, an indication of a set of beams associated with the TRP; and transmitting, to the TRP, an indication of another set of beams associated with another TRP of the plurality of TRPs in at least one of a Msg3 communication, a communication after completing the RACH procedure, or a small data transmission after receiving a MsgB communication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

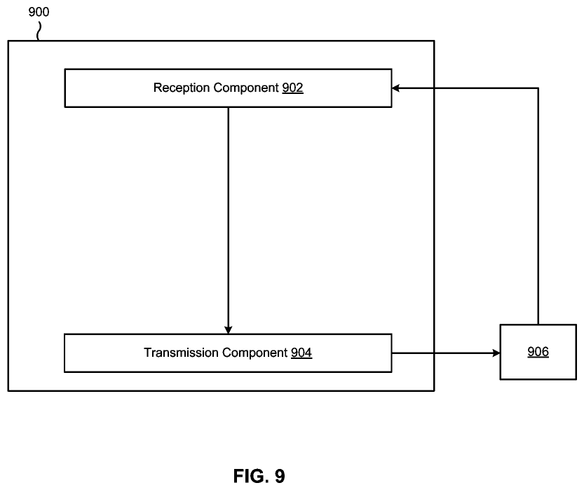

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904.

In some aspects, the apparatus 900 may be configured to perform one or more operations described herein in connection with FIGS. 3-7. Additionally, or alternatively, the apparatus 900 may be configured to perform one or more processes described herein, such as process 800 of FIG. 8 or a combination thereof. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be co-located with the reception component 902 in a transceiver.

The transmission component 904 may transmit beam information, associated with the apparatus 900, during a RACH procedure and while in an inactive mode or in an idle mode. The apparatus 900 may remain in the inactive mode or in the idle mode after the transmission component 904 transmits the beam information.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of aspects of the present disclosure:

Aspect 1: A method of wireless communication performed by a user equipment (UE), comprising: transmitting beam information, associated with the UE, during a random access channel (RACH) procedure and while in an inactive mode or in an idle mode; and remaining in the inactive mode or in the idle mode after transmitting the beam information.

Aspect 2: The method of aspect 1, wherein the beam information identifies one or more beams on which the UE is to be paged while the UE is in the inactive mode or in the idle mode. Aspect 3: The method of aspect 1 or 2, wherein transmitting the beam information comprises: transmitting the beam information based at least in part on mobility of the UE.

Aspect 4: The method of any of aspects 1-3, wherein the RACH procedure is a type 1 RACH procedure; and wherein transmitting the beam information comprises: transmitting the beam information in a message 1 (Msg1) communication in the type 1 RACH procedure, wherein a combination of a RACH preamble of the Msg1 communication and a RACH occasion in which the Msg1 communication is transmitted implicitly indicates the beam information. Aspect 5: The method of any of aspects 1-3, wherein the RACH procedure is a type 2 RACH procedure; and wherein transmitting the beam information comprises: transmitting the beam information in a message A (MsgA) communication in the type 2 RACH procedure, wherein a combination of a RACH preamble of the MsgA communication and a RACH occasion in which the MsgA communication is transmitted implicitly indicates the beam information.

Aspect 6: The method of any of aspects 1-4, wherein the RACH procedure is a type 1 RACH procedure; and wherein transmitting the beam information comprises: transmitting the beam information in a message 3 (Msg3) communication in the type 1 RACH procedure.

Aspect 7: The method of any of aspects 1-4 or 6, wherein the RACH procedure is a type 1 RACH procedure; and wherein transmitting the beam information comprises: transmitting the beam information after completing the type 1 RACH procedure. Aspect 8: The method of any of aspects 1-3 or 5, wherein the RACH procedure is a type 2 RACH procedure; and wherein transmitting the beam information comprises: transmitting the beam information in a payload of a message A (MsgA) communication in the type 2 RACH procedure.

Aspect 9: The method of any of aspects 1-3, 5 or 6, wherein the RACH procedure is a type 2 RACH procedure; and wherein transmitting the beam information comprises: transmitting the beam information in a small data transmission after receiving a message B (MsgB) communication in the type 2 RACH procedure. Aspect 10: The method of any of aspects 1-9, wherein the beam information identifies a respective set of beams for each transmit receive point (TRP) of a plurality of TRPs; and wherein transmitting the beam information comprises: transmitting the beam information to each TRP of the plurality of TRPs during respective RACH procedures associated with each TRP of the plurality of TRPs and while in the inactive mode or in the idle mode.

Aspect 11: The method of any of aspects 1-9, wherein the beam information identifies a respective set of beams for each transmit receive point (TRP) of a plurality of TRPs; and wherein transmitting the beam information comprises: transmitting the beam information to a TRP of the plurality of TRPs during the RACH procedure and while in the inactive mode or in the idle mode. Aspect 12: The method of aspect 11, wherein transmitting the beam information comprises: transmitting, to the TRP and in a message 1 (Msg1) communication, an indication of a set of beams associated with the TRP; and transmitting, to the TRP, an indication of another set of beams associated with another TRP of the plurality of TRPs in at least one of: a message 3 (Msg3) communication, a communication after completing the RACH procedure, or a small data transmission after receiving a message B (MsgB) communication.

Aspect 13: An apparatus for wireless communication at a device, comprising a processor; memory coupled with the processor; and instructions stored in the memory and executable by the processor to cause the apparatus to perform the method of one or more aspects of aspects 1-12. Aspect 14: A device for wireless communication, comprising a memory and one or more processors coupled to the memory, the memory and the one or more processors configured to perform the method of one or more aspects of aspects 1-12.

Aspect 15: An apparatus for wireless communication, comprising at least one means for performing the method of one or more aspects of aspects 1-12. Aspect 17: A non-transitory computer-readable medium storing a set of instructions for wireless communication, the set of instructions comprising one or more instructions that, when executed by one or more processors of a device, cause the device to perform the method of one or more aspects of aspects 1-12.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
transmitting beam information, associated with the UE, during a random access channel (RACH) procedure and while in an inactive mode or in an idle mode; and
remaining in the inactive mode or in the idle mode after transmitting the beam information.

2. The method of claim 1, wherein the beam information identifies one or more beams on which the UE is to be paged while the UE is in the inactive mode or in the idle mode.

3. The method of claim 1, wherein transmitting the beam information comprises:
transmitting the beam information based at least in part on mobility of the UE.

4. The method of claim 1, wherein the RACH procedure is a type 1 RACH procedure; and
wherein transmitting the beam information comprises:
transmitting the beam information in a message 1 (Msg1) communication in the type 1 RACH procedure,
wherein a combination of a RACH preamble of the Msg1 communication and a RACH occasion in which the Msg1 communication is transmitted implicitly indicates the beam information.

5. The method of claim 1, wherein the RACH procedure is a type 2 RACH procedure; and
wherein transmitting the beam information comprises:
transmitting the beam information in a message A (MsgA) communication in the type 2 RACH procedure,
wherein a combination of a RACH preamble of the MsgA communication and a RACH occasion in which the MsgA communication is transmitted implicitly indicates the beam information.

6. The method of claim 1, wherein the RACH procedure is a type 1 RACH procedure; and
wherein transmitting the beam information comprises:
transmitting the beam information in a message 3 (Msg3) communication in the type 1 RACH procedure.

7. The method of claim 1, wherein the RACH procedure is a type 1 RACH procedure; and
wherein transmitting the beam information comprises:
transmitting the beam information after completing the type 1 RACH procedure.

8. The method of claim 1, wherein the RACH procedure is a type 2 RACH procedure; and
wherein transmitting the beam information comprises:
transmitting the beam information in a payload of a message A (MsgA) communication in the type 2 RACH procedure.

9. The method of claim 1, wherein the RACH procedure is a type 2 RACH procedure; and
wherein transmitting the beam information comprises:
transmitting the beam information in a small data transmission after receiving a message B (MsgB) communication in the type 2 RACH procedure.

10. The method of claim 1, wherein the beam information identifies a respective set of beams for each transmit receive point (TRP) of a plurality of TRPs; and
wherein transmitting the beam information comprises:
transmitting the beam information to each TRP of the plurality of TRPs during respective RACH procedures associated with each TRP of the plurality of TRPs and while in the inactive mode or in the idle mode.

11. The method of claim 1, wherein the beam information identifies a respective set of beams for each transmit receive point (TRP) of a plurality of TRPs; and
wherein transmitting the beam information comprises:
transmitting the beam information to a TRP of the plurality of TRPs during the RACH procedure and while in the inactive mode or in the idle mode.

12. The method of claim 11, wherein transmitting the beam information comprises:
transmitting, to the TRP and in a message 1 (Msg1) communication, an indication of a set of beams associated with the TRP; and
transmitting, to the TRP, an indication of another set of beams associated with another TRP of the plurality of TRPs in at least one of:
a message 3 (Msg3) communication,
a communication after completing the RACH procedure, or
a small data transmission after receiving a message B (MsgB) communication.

13. A user equipment (UE) for wireless communication, comprising:
a memory; and
one or more processors operatively coupled to the memory, the memory and the one or more processors configured to:
transmit beam information, associated with the UE, during a random access channel (RACH) procedure and while in an inactive mode or in an idle mode; and
remain in the inactive mode or in the idle mode after transmitting the beam information.

14. The UE of claim 13, wherein the beam information identifies one or more beams on which the UE is to be paged while the UE is in the inactive mode or in the idle mode.

15. The UE of claim 13, wherein the one or more processors, when transmitting the beam information, are configured to:
transmit the beam information based at least in part on mobility of the UE.

16. The UE of claim 13, wherein the RACH procedure is a type 1 RACH procedure; and
wherein the one or more processors, when transmitting the beam information, are configured to:
transmit the beam information in a message 1 (Msg1) communication in the type 1 RACH procedure,
wherein a combination of a RACH preamble of the Msg1 communication, and a RACH occasion in which the Msg1 communication is transmitted, implicitly indicates the beam information.

17. The UE of claim 13, wherein the RACH procedure is a type 2 RACH procedure; and
wherein the one or more processors, when transmitting the beam information, are configured to:
transmit the beam information in a message A (MsgA) communication in the type 2 RACH procedure,
wherein a combination of a RACH preamble of the MsgA communication, and a RACH occasion in which the MsgA communication is transmitted, implicitly indicates the beam information.

18. The UE of claim 13, wherein the RACH procedure is a type 1 RACH procedure; and
wherein the one or more processors, when transmitting the beam information, are configured to:
transmit the beam information in a message 3 (Msg3) communication in the type 1 RACH procedure.

19. The UE of claim 13, wherein the RACH procedure is a type 1 RACH procedure; and
wherein the one or more processors, when transmitting the beam information, are configured to:
transmit the beam information after completing the type 1 RACH procedure.

20. The UE of claim 13, wherein the RACH procedure is a type 2 RACH procedure; and
wherein the one or more processors, when transmitting the beam information, are configured to:
transmit the beam information in a payload of a message A (MsgA) communication in the type 2 RACH procedure.

21. The UE of claim 13, wherein the RACH procedure is a type 2 RACH procedure; and
wherein the one or more processors, when transmitting the beam information, are configured to:
transmit the beam information in a small data transmission after receiving a message B (MsgB) communication in the type 2 RACH procedure.

22. The UE of claim 13, wherein the beam information identifies a respective set of beams for each transmit receive point (TRP) of a plurality of TRPs; and
wherein the one or more processors, when transmitting the beam information, are configured to:
transmit the beam information to each TRP of the plurality of TRPs during respective RACH procedures associated with each TRP of the plurality of TRPs and while in the inactive mode or in the idle mode.

23. The UE of claim 13, wherein the beam information identifies a respective set of beams for each transmit receive point (TRP) of a plurality of TRPs; and
wherein the one or more processors, when transmitting the beam information, are configured to:
transmit the beam information to a TRP of the plurality of TRPs during the RACH procedure and while in the inactive mode or in the idle mode.

24. The UE of claim 23, wherein the one or more processors, when transmitting the beam information, are configured to:
transmit, to the TRP and in a message 1 (Msg1) communication, an indication of a set of beams associated with the TRP; and
transmit, to the TRP, an indication of another set of beams associated with another TRP of the plurality of TRPs in at least one of:
a message 3 (Msg3) communication,
a communication after completing the RACH procedure, or
a small data transmission after receiving a message B (MsgB) communication.

25. A non-transitory computer-readable medium storing one or more instructions for wireless communication, the one or more instructions comprising:
one or more instructions that, when executed by one or more processors of a user equipment (UE), cause the one or more processors to:
transmit beam information, associated with the UE, during a random access channel (RACH) procedure and while in an inactive mode or in an idle mode; and
remain in the inactive mode or in the idle mode after transmitting the beam information.

26. The non-transitory computer-readable medium of claim 25, wherein the beam information identifies one or more beams on which the UE is to be paged while the UE is in the inactive mode or in the idle mode.

27. The non-transitory computer-readable medium of claim 25, wherein the one or more instructions, that cause the one or more processors to transmit the beam information, cause the one or more processors to:
transmit the beam information based at least in part on mobility of the UE.

28. An apparatus for wireless communication, comprising:
means for transmitting beam information, associated with the apparatus, during a random access channel (RACH) procedure and while in an inactive mode or in an idle mode; and
means for remaining in the inactive mode or in the idle mode after transmitting the beam information.

29. The apparatus of claim 28, wherein the beam information identifies one or more beams on which the apparatus is to be paged while the apparatus is in the inactive mode or in the idle mode.

30. The apparatus of claim 28, wherein the means for transmitting the beam information comprises:
means for transmitting the beam information based at least in part on mobility of the apparatus.
